(19) United States
(12) Patent Application Publication
(10) Pub. No.: US 2020/0093314 A1
(43) Pub. Date: Mar. 26, 2020

(54) Filter Assembly for Beverage Additives

(71) Applicant: Darren Gamache, Toppenish, WA (US)

(72) Inventor: Darren Gamache, Toppenish, WA (US)

(21) Appl. No.: 16/140,331

(22) Filed: Sep. 24, 2018

(51) Int. Cl. A47J 31/06; A47J 31/20; A47G 19/16; B65D 85/812

(52) U.S. Cl. CPC A47J 31/0626; A47J 31/20; A47J 31/0636; B65D 85/812; A47G 19/16

(57) ABSTRACT

A filter assembly for infusing an additive in a liquid. The filter assembly comprises an elongated filter bag that is rigidly reinforced along its vertical length and removably securable to the side of the vessel containing the liquid, to prevent flotation of the filter assembly and its contents. In an embodiment, the lower portion of the elongated filter bag is pre-filled with an additive and closed off to retain the additive in the lower portion. The filter assembly may be disposable. The invention further includes a method of dry-hopping beer using the disclosed filter assembly.

### BACKGROUND OF THE INVENTION

It has long been known to add flavorings, colorings, and other additives to liquids by infusing the additive in the liquid using a reusable or disposable filter device. For example, disposable “tea bags” are commonly used to neatly and quickly prepare an infused beverage. One problem that can arise with the use of tea bags and other disposable filter devices is that the buoyancy of the additive, the surface tension of the filter material, or a combination of the two, can cause the filter device to float on the surface of the beverage, resulting in less than complete infusion of the additive in the liquid.

Buoyancy is a particular problem encountered when infusing a finished beer beverage with fresh or dry hops immediately prior to consuming (“dry-hopping”). Dry-hopping allows the consumer to add hop cones, leaves, pellets, or powder to their beer, just prior to consumption, for flavoring and other beneficial effects. It is known to use a tea bag, filter bag, or natural or synthetic straining cloth to dry-hop beer, but these filtering devices tend to float due to the buoyancy of the hops. An additional problem encountered when using known filtering devices for dry hopping is the tendency of the beer to become de-carbonated during the process.

### BRIEF SUMMARY OF THE INVENTION

The present invention addresses the above problems by providing a submersible filter assembly for infusing an additive in a liquid. The filter assembly comprises an elongated filter bag that is rigidly reinforced along its vertical length and removably securable to the side of the vessel containing the liquid, to prevent flotation of the filter assembly and its contents. In an embodiment, the lower portion of the elongated filter bag is pre-loaded with an additive and closed off to retain the additive in the lower portion. The invention further includes a method of dry-hopping beer using the disclosed filter assembly.

### BRIEF DESCRIPTION OF THE DRAWINGS

FIG. 1 is a plan view of the filter assembly;

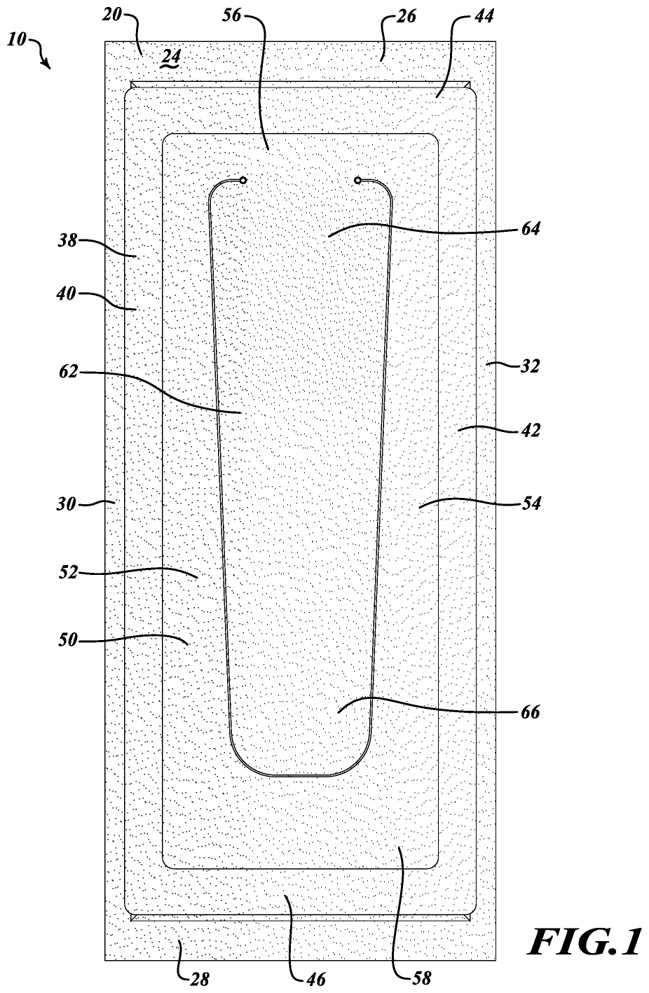

FIG. 2 is a plan view of the stays and hanging frame of the filter assembly;

FIG. 3 is a side view of the filter assembly with the hanging frame spaced away from the stays and filter bag;

FIG. 3B is a side view of the filter assembly with hanging frame spaced away from the stays and filter bag, wherein the lower portion of the filter bag is pre-filled and sealed off;

FIG. 4 is a rear perspective view of the filter assembly;

FIG. 5A is a front perspective view of the filter assembly;

FIG. 5B is a front perspective view of the filter assembly, wherein the lower portion of the filter bag is pre-filled and sealed off;

FIG. 6 is a perspective view of the filter assembly positioned on a drinking glass; and

FIG. 7 is a top view of the filter assembly.

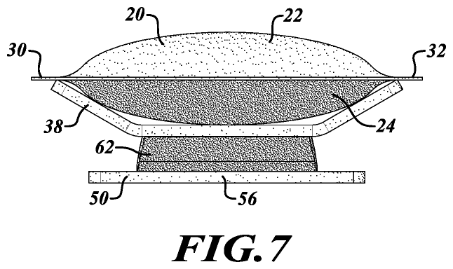

### DETAILED DESCRIPTION OF THE INVENTION

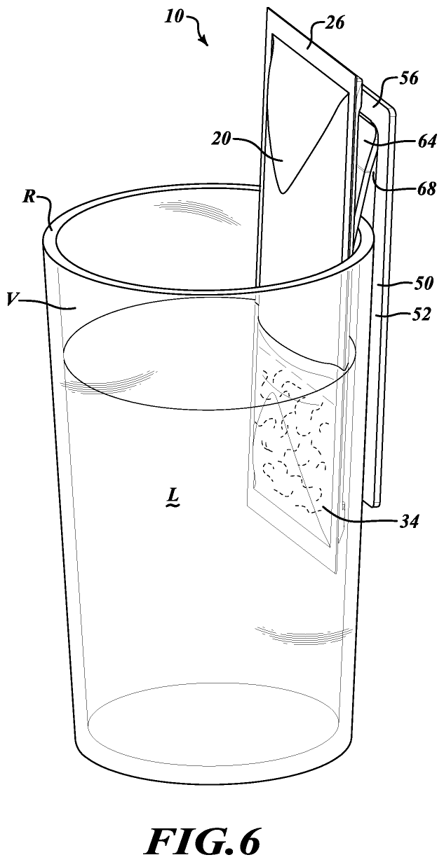

The filter assembly 10 generally comprises a filter bag, stays, and a hanging frame. One or more stays are affixed to a side of the filter bag to provide rigidity and prevent the filter bag from floating up during use due to surface tension or buoyancy of an additive A. The hanger is also affixed to a side of the filter bag. The hanger suspends the filter bag on the rim R of a vessel V containing a liquid L as shown in FIG. 6. Typically the vessel is a cup, glass or mug, but could be any container suitable for holding liquid and having a rim upon which a filter assembly could be suspended. Details of a preferred embodiment of the invention are set forth below.

A filter bag 20 is adapted to hold an additive A to be infused into a liquid L. The additive can be a flavoring or coloring additive; plant material such as tea, herbs, or hops; or any other desired additive. For the purposes of this invention, a hop additive may take the form of fresh or dried hops; hop bracts; hop powder; hop pellets; hop flavoring agents; effervescent medium infused with a hop-based flavoring agent; or any other solid form of fresh or processed hops.

The filter bag 20 has a front side 22 and an opposing back side 24, and is elongated to allow sufficient space and surface area for the additive A to be at least partially, and preferably fully, submerged in liquid L when the filter assembly 10 is in use. The filter bag has a top edge 26, bottom edge 28, and opposing side edges 30 and 32, and is constructed of filter material having a porosity selected to allow the passage of the liquid but not the additive.

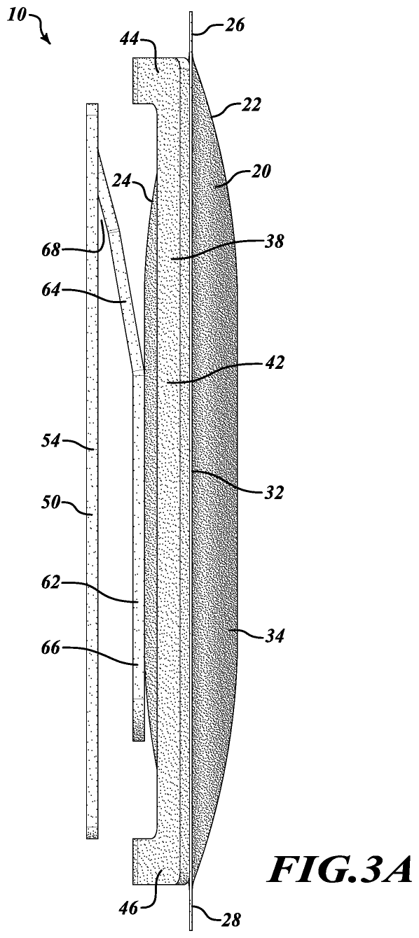

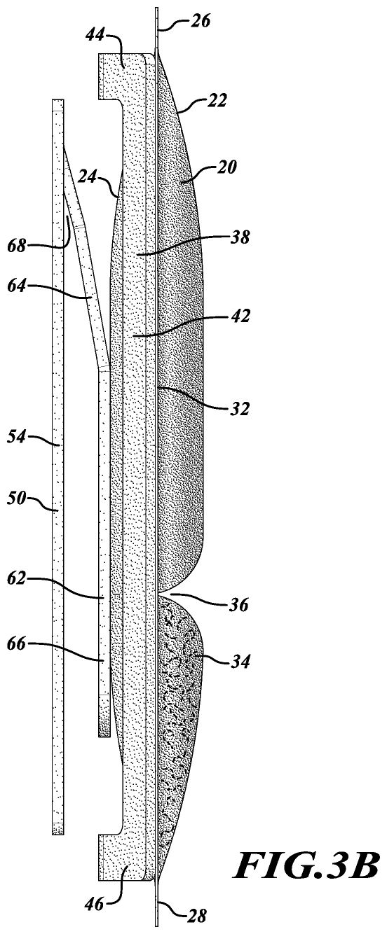

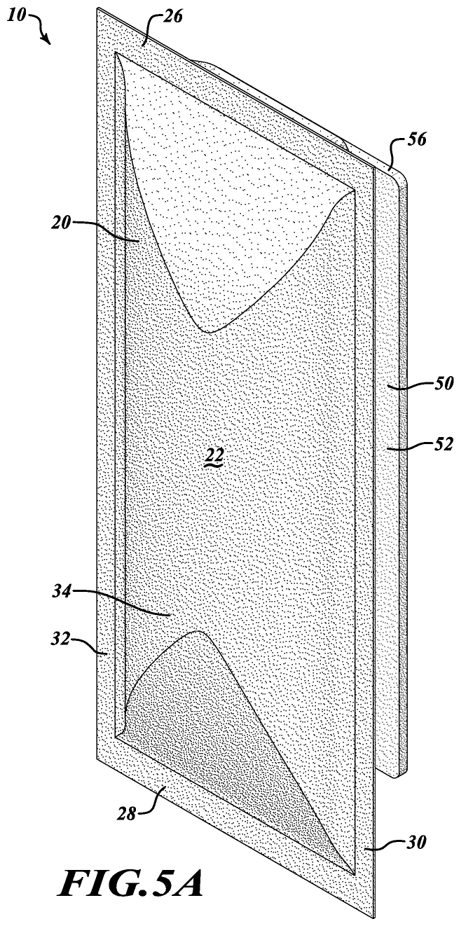

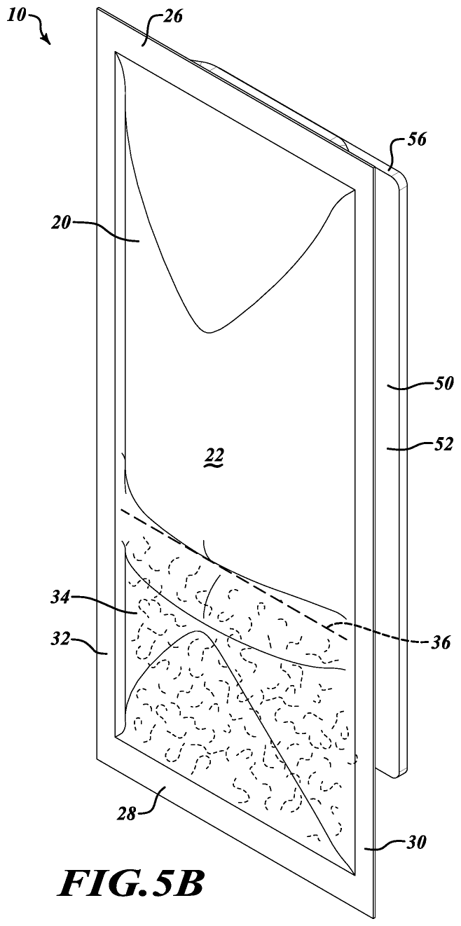

In a preferred embodiment of the invention, the filter bag 20 is pre-filled as shown in FIG. 3B and FIG. 5B. The lower portion 34 of the filter bag contains the additive A. A closure 36 is provided to retain the additive in the lower portion, and may be a heat weld, adhesive, stitching, or any other effective closure known in the art. In the case of a pre-filled filter bag, the top edge 26 is sealed. In an alternative embodiment, the top edge is not sealed, thus allowing the user to select an additive and put the additive in the filter bag.

One or more stays 38 are affixed to the back side 24 of the filter bag 20 to provide rigidity to the filter bag, conform the filter bag to a vessel V, and prevent the filter bag from floating in the liquid L. Elongated, substantially vertical stays 40 and 42 extend from the near the top edge 26 to near the bottom edge 28 of the filter bag. The rigidity of the vertical stays is sufficient to resist the buoyant force of the liquid on an additive A, and any surface tension on the filter bag. When the filter bag contains an additive that will float, the rigid vertical stays retain the filter bag in a vertical orientation and prevent it from floating up.

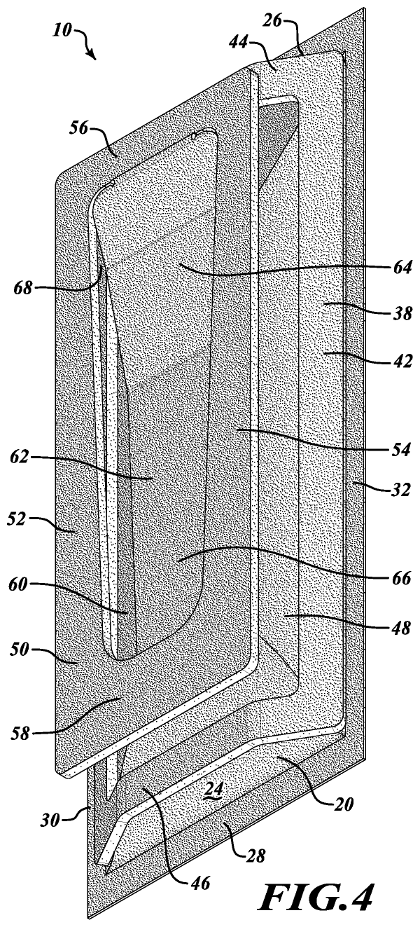

One or more optional horizontal stays may be affixed to the back side 24 of the filter bag 20 to provide structure and conformability to the top edge 26 and the bottom edge 28 of the filter bag. As shown in FIG. 4, upper horizontal stay 44 is affixed to and extends across the upper edge 26 of the filter bag. Optional lower horizontal stay 46 is affixed to and extends across the lower edge 28 of the filter bag. In use, the horizontal stays can be bent slightly if necessary to conform to the vessel V.

In an embodiment, vertical stays 40 and 42 and horizontal stays 44 and 46 form a first frame which, when adhered to the back side 24 of the filter bag 20, provides the requisite rigidity and conformability. The first frame defines a first open space 48.

The hanging frame 50 is adapted to suspend the filter bag 20 on the rim R of a vessel V as shown in FIG. 6. In an embodiment, the hanging frame is a second frame formed within the first open space 48. Opposing, substantially vertical hanging frame members 52 and 54 connected by a substantially horizontal hanging frame upper member 56 and hanging frame upper member 58 form the four sides of the hanging frame, which is free and not attached to the filter bag. The hanging frame defines a second open space 60.

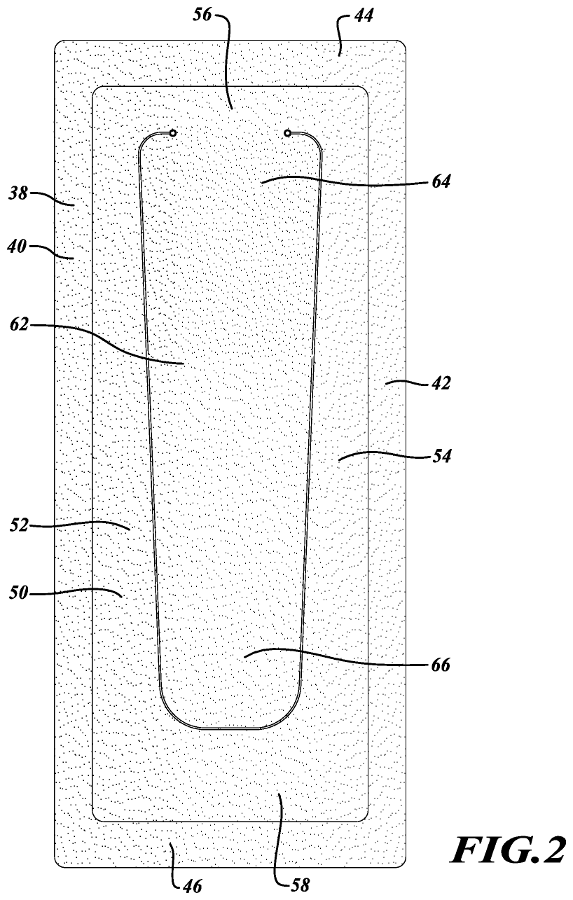

A tongue 62, comprising an upper portion 64 and a lower portion 66, is formed within the second open space 60 formed by the hanging frame 50 and is contiguous with the hanging frame upper member 56, extending downwardly therefrom, as shown in FIG. 2. The tongue lower portion is affixed to the back side of the filter bag 20, and the tongue upper portion and the hanging frame upper member are left free and unattached, as best seen in FIGS. 3A, 3B, and 4.

In use, a notch 68 formed between the vertical hanging frame members 52 and 54 and the tongue upper portion rests on the vessel rim R to suspend the filter assembly, with the filter bag on the inside of the vessel V, and the hanging frame on the outside of the vessel. The notch is closed until the vertical hanging frame members are gently pulled away from the tongue upper portion 64. Due to the rigidity of the sheet material, the vertical hanging frame members tend to spring back, such that the notch becomes a “clamp” that grips the rim of the vessel and keeps the filter assembly 10 from floating. The unattached tongue upper portion is conformable to the shape and thickness of the vessel rim.

The stays 38, hanging frame 50, and tongue 62 of the filter assembly 10 disclosed herein are preferably cut in a single piece of thin and rigid but bendable sheet material, as shown in FIG. 2. In a preferred embodiment, the sheet material is coated paper. An adhesive is applied to only the stays and the tongue lower portion 66 to adhere them to the back side 24 of the filter bag 20, leaving the hanging frame and tongue upper portion 64 free. An advantage of this preferred embodiment is that the filter assembly so constructed is disposable and potentially biodegradable. A single-use filter assembly is suitable for sale in bars, restaurants and the like, as well as for retail sale.

The present invention further comprises a method for dry-hopping beer, using a filter assembly 10 as described herein. Preferably the filter bag 20 is pre-filled with a selected additive A. In an alternate embodiment of the method of the invention, a user fills the filter bag with a hop additive and, if desired, seals the hop additive in the lower portion 34 of the filter using a closure 36. The filter assembly is suspended on the rim of a vessel V by extending the hanging frame 50 away from the filter bag, positioning the filter bag and stays 38 on the inside of the vessel, and positioning the hanging frame on the outside of the vessel. In an embodiment of the method, the horizontal stays 44 and 46, the hanging frame upper member 56, and the tongue upper portion 64 are gently shaped or bent by the user to conform them to the shape and thickness of vessel rim R. The notch 68 forms a “clamp” that grips the rim R and prevents the filter assembly from floating in the liquid L, as shown in FIG. 6. According to the invention, beer may be added to the vessel before or after positioning the filter assembly in the glass as described.

Minimized decarbonation of beer is an unexpected result of the present invention. This is believed to be the result of the non-mechanical infusion process, the preparation of the hop additive used, and the reduced number of nucleation sites as compared to known methods.

In compliance with the statutes, the invention has been described in language more or less specific as to structural features and process steps. While this invention can be embodied in different forms, the specification describes and illustrates preferred embodiments of the invention. It is to be understood that this disclosure is an exemplification of the principles of the invention, and is not intended to limit the invention to the particular embodiments described. Those with ordinary skill in the art will appreciate that other embodiments and variations of the invention, which employ the same inventive concepts as the invention, are possible. Therefore, the invention is not to be limited except by the following claims.

1. A filter assembly for infusing an additive into a liquid contained in a vessel having a rim, the filter assembly comprising:
a filter bag for containing the additive, the filter bag having a front side and an opposing back side;
at least one elongated substantially vertical stay affixed along the length of the filter bag; and,
a hanger affixed to the filter bag for suspending the filter assembly on the vessel rim, the hanger adapted to grip the vessel rim to prevent flotation of the filter assembly.

2. The filter assembly of claim 1, wherein the filter bag is formed of a fine mesh material that allows passage of the liquid but not the additive.

3. The filter assembly of claim 1, further comprising an additive sealed within the filter bag.

4. The filter assembly of claim 3, where in the hop additive is selected from the group consisting of fresh hops, dried hops, hop bracts, hop powder, hop pellets, hop flavoring agents, and effervescent mediums infused with hop-based flavoring agents.

5. The filter assembly of claim 3, further comprising a closure for sealing the additive in a lower portion of the filter bag.

6. A beer dry-hopping assembly, the assembly comprising:
a filter bag having a front side and an opposing back side;
a hop additive contained within the filter bag;
at least one elongated substantially vertical stay affixed to a side of the filter bag to prevent the filter bag from floating; and,
a hanging frame affixed to a side of the filter bag for suspending the dry-hopping assembly on the rim of a vessel having a rim, the hanging frame adapted to grip the rim.

7. The beer dry-hopping assembly of claim 6, wherein the hop additive is sealed within a lower portion of the filter bag.

8. The beer dry-hopping assembly of claim 6, wherein the hop additive is selected from the group consisting of fresh hops, dried hops, hop bracts, hop powder, hop pellets, hop flavoring agents, and effervescent mediums infused with hop-based flavoring agents.

9. A non-floating filter assembly for infusing an additive into a liquid contained in a vessel having a rim, the filter assembly comprising:
an elongated filter bag for containing the additive, the filter bag having a front side and an opposing back side;
an outer frame affixed to the back side of the filter bag for providing rigidity to the filter bag, the outer frame comprising a pair of elongated substantially vertical stays, an upper substantially horizontal stay, and a lower substantially horizontal stay, the stays arranged to form a frame defining a first open space;
a hanging frame formed within the first open space, the hanging frame comprising a pair of substantially vertical hanging frame members, a substantially horizontal upper hanging frame member, and a substantially horizontal lower hanging frame member, the hanging frame members arranged to form a frame defining a second open space;
a tongue formed within the second open space, the tongue having a lower portion affixed to the filter bag, and an upper portion contiguous with the substantially horizontal upper hanging frame member, wherein a notch formed by the tongue upper portion and the substantially vertical hanging frame members is adapted to grip the rim of the vessel so as to prevent flotation of the filter assembly.

10. The non-floating filter assembly of claim 9, wherein the outer frame, the hanging frame and the tongue are die-cut from a single piece of sheet-like material.

11. The non-floating filter assembly of claim 9, further comprising an additive sealed within a lower portion of the filter bag.

12. The non-floating filter assembly of claim 11, wherein the additive is selected from the group consisting of fresh hops, dried hops, hop bracts, hop powder, hop pellets, hop flavoring agents, and effervescent mediums infused with hop-based flavoring agents.

13. The non-floating filter assembly of claim 12, wherein the filter assembly comprises a single-use disposable unit.

14. A method for dry-hopping beer in a glass immediately prior to consumption using a non-floating filter assembly, the filter assembly comprising an elongated filter bag containing a hop additive, at least one substantially vertical stay affixed to the filter bag, and a hanger affixed to the filter bag and adapted to grip the edge of the glass, the method comprising the steps of:
Filling the glass with beer;
Hanging the filter assembly on the glass, whereby the hanger grips the edge of the glass to prevent the filter assembly from floating; and,
Allowing the hop additive to infuse the beer until the desired flavor is achieved.
